(19) United States
(12) Patent Application Publication
(10) Pub. No.: US 2024/0270660 A1
(43) Pub. Date: Aug. 15, 2024

(54) LIQUID COMPOSITIONS COMPRISING DISSOLVED THIOSULFATE AND SUSPENDED SOLIDS

(71) Applicant: Tessenderlo Group NV, Brussels (BE)

(72) Inventors: Thomas David Fairweather, Phoenix, AZ (US); Sun Young Wallace, Phoenix, AZ (US)

(73) Assignee: Tessenderlo Group NV, Brussels (BE)

(21) Appl. No.: 18/565,115

(22) PCT Filed: Jun. 2, 2022
(86) PCT No.: PCT/EP2022/065041

§ 371 Date: Nov. 29, 2023

(30) Foreign Application Priority Data
Jun. 3, 2021 (EP) 21177586.1

(51) Int. Cl. C05G 5/27; C05B 17/00; C05C 3/00; C05D 1/00; C05D 3/02; C05D 9/00; C05G 3/50; C05G 3/70

(52) U.S. Cl. CPC C05G 5/27; C05B 17/00; C05C 3/00; C05D 1/00; C05D 3/02; C05D 9/00; C05G 3/50; C05G 3/70

(57) ABSTRACT

The present invention relates to liquid compositions useful as fertilizers comprising water; a thiosulfate salt dissolved in the aqueous liquid; a solid suspended in the aqueous liquid. The present invention further relates to methods for producing said liquid compositions and the use thereof as fertilizer, in particular for spray or fertigation applications.

### FIELD OF THE INVENTION

The present invention relates to liquid compositions comprising thiosulfates and suspended solids. The present invention further relates to methods for producing said liquid compositions and the use thereof as fertilizers, in particular in irrigation and fertigation systems.

### BACKGROUND OF THE INVENTION

It is known that aqueous fertilizer compositions in a liquid form present several advantages compared with fertilizer compositions in a solid form. The preparation of such liquid aqueous compositions avoids granulating and drying steps and obviates other drawbacks such as caking or dust formation. Furthermore, liquid aqueous compositions can be used in various application methods such as broadcast soil and sidedress applications, and in particular fertigation or foliar application.

Aqueous fertilizer compositions are exist in a liquid form as solution and/or as suspension. In solution, the fertilizers are dissolved in water and, in suspension, the fertilizers are still present as a solid phase and have to remain as a stable suspension in water until the fertilizer is used. Settling of the suspension, or salting out, leads to problems such as inaccurate dosing and clogging of irrigation systems or foliar spray systems (e.g. spray bars).

A serious challenge in the formulation of liquid fertilizer resides in (i) the limited solubility of most of the various salts comprising the nutrients themselves, thereby making it difficult to obtain product concentrates, and (ii) the limited stability of suspensions when prepared using a liquid phase already comprising dissolved fertilizers due to high ionic strength of the solution. In many suspension and colloidal systems, increasing ionic strength of the aqueous phase weakens particle-particle and particle-interface repulsive electrostatic forces, leading to destabilization of the suspension.

Calcium and sulfur, along with magnesium are part of secondary nutrients and like the primary nutrients (NPK), are essential for plant health and growth, although in lesser amounts than the primary nutrients. Sulfur is termed as the secondary nutrient only to refer to its quantity, not its importance in the healthy growth of the plants and crops. Sulfur is essential for nitrogen fixation in nodules on legumes, and it is necessary in the formation of chlorophyll. Plants use sulfur for producing proteins, amino acids, enzymes, and vitamins for a healthy growth. Sulfur generates resistance to disease. Most of the sulfur in soils is found in soil inorganic matter. However, it is not available to plants in this form. In order to become available to plants, the sulfur must be first released from the organic matter and go through mineralization process. The mineralization process is a result of microbial activity. In this process sulfur is converted to the sulfate form (SO₄²⁻), which is readily available to plants. Oil crops, legumes, forages and some vegetable crops require sulfur in considerable amounts. In many crops, its amount in the plant is similar to phosphorus. Although it is considered a secondary nutrient, it is now becoming recognized as the ‘fourth macronutrient’, along with nitrogen, phosphorus and potassium. Sulfur deficiency symptoms show up as light green to yellowish color. Deficient plants are small and their growth is retarded. Symptoms may vary between plant species. For example, in corn, sulfur deficiency shows up as interveinal chlorosis; in wheat, the whole plant becomes pale while the younger leaves are more chlorotic; in potatoes, spotting of leaves might occur.

U.S. Pat. No. 5,863,861 is directed at providing suspensions of potassium in water for use in drip irrigation.

US2021114946A1 concerns aqueous dispersions of potassium calcium polyphosphate as liquid fertilizers.

It is an object of the present invention to provide a stable aqueous liquid fertilizer comprising large amounts of sulfur as well as other plant nutrients. In particular, it is an object to provide an aqueous liquid fertilizer comprising large amounts of sulfur as well as other plant nutrients, which is stable upon storage for several months and which can be used in irrigation systems or foliar spray systems (or applied as side dress or directly to the soil by spraying or soil injection) without clogging the apertures or holes of the system.

### SUMMARY OF THE INVENTION

The present inventors have surprisingly found that one or more objects of the invention is achieved by using dissolved thiosulfates as the liquid bulk for suspending solids. Indeed, as is shown in the appended examples, it was found that despite the high ionic strength of concentrated thiosulfate solutions, stable suspensions with various fertilizing solids, in particular sulfates, carbonates or elemental sulfur can be achieved.

Hence, the present inventors have for the first time provided a platform of stable liquid fertilizers suitable for use in fertigation or foliar applications (but may also be applied as side-dress or directly to the soil by spraying or soil injection) which have a high sulfur content and can be provided in a form bringing even higher sulfur doses (e.g. when the solids are sulfates or elemental sulfur), or in a form which brings a more complete nutrient profile (e.g. when the solids are a calcium source such as gypsum or calcium carbonate).

In a first aspect of the invention, there is provided a stable aqueous liquid composition comprising
water;
a thiosulfate salt dissolved in the aqueous liquid;
a solid suspended in the aqueous liquid; and
a rheology modifier.

The liquid composition is preferably a liquid fertilizer.

The rheology modifier is preferably provided in an amount such that the composition has a viscosity within the range of 500-10,000 mPa*s (cps).

In preferred embodiments the thiosulfate salt is selected from the group consisting of calcium thiosulfate, magnesium thiosulfate, potassium thiosulfate, ammonium thiosulfate, ferrous thiosulfate, manganese thiosulfate and combinations thereof, preferably wherein the thiosulfate salt is selected from the group consisting of calcium thiosulfate, potassium thiosulfate, ammonium thiosulfate and combinations thereof; and the solid comprises a sulfate salt, a carbonate salt, a phosphate salt or elemental sulfur.

In preferred embodiments, a stable aqueous liquid composition is provided comprising
10-90 wt. % (by total weight of the liquid composition) water;
at least 5 wt. % (by total weight of the liquid composition) of a thiosulfate salt dissolved in the aqueous liquid;
at least 10 wt. % (by total weight of the liquid composition) of a solid suspended in the aqueous liquid; and
at least 0.01 wt. % (by total weight of the liquid composition) of a rheology modifier, preferably in an amount such that the composition has a viscosity within the range of 500-10,000 mPa's (cps),
wherein the thiosulfate salt is selected from the group consisting of calcium thiosulfate, magnesium thiosulfate, potassium thiosulfate, ammonium thiosulfate, ferrous thiosulfate, manganese thiosulfate and combinations thereof, preferably wherein the thiosulfate salt is selected from the group consisting of calcium thiosulfate, potassium thiosulfate, ammonium thiosulfate and combinations thereof; and wherein the suspended solid comprises a sulfate salt, a carbonate salt, a phosphate salt or elemental sulfur; and
wherein the suspended solid has Dv(25) of 5 micron or more and a Dv(75) of 100 micron or less as determined by laser diffraction; and
wherein the composition comprises 0.05-10 wt % (by total weight of the liquid composition) of a dispersant selected from the group consisting of:
sulfonates of branched or straight-chain C₅-C₂₄ alkyls;
sulfonates of alkylnaphthalene groups comprising a C₁-C₁₅ alkyl;
sulfonates of alkylbenzene groups comprising a C₁-C₁₅ alkyl;
phosphate esters of ethoxylated C₅-C₂₄ alkyls;
lignosulfonates; and
combinations thereof; and
wherein the rheology modifier is selected from the group consisting of starch or a derivative thereof, xanthan gum or a derivative thereof, guar gum or a derivative thereof, diutan gum or a derivative thereof, locust bean gum or a derivative thereof, and combinations thereof, wherein derivatives are selected from acetate derivatives, carboxymethyl derivatives, hydroxypropyl derivatives, hydroxypropylmethyl derivatives, methyl derivatives, hydroxyethyl derivatives, hydroxymethyl derivatives, ethylene glycol derivative, and propylene glycol derivatives of the aforementioned polysaccharides. In other words, this embodiment is provided wherein the rheology modifier is selected from the group consisting of starch or a derivative thereof, xanthan gum or a derivative thereof, guar gum or a derivative thereof, diutan gum or a derivative thereof, locust bean gum or a derivative thereof, and combinations thereof, wherein derivatives are selected from these polysaccharides (i.e. starch, xanthan gum, guar gum, diutan gum, locust bean gum, and combinations thereof) modified with acetate, carboxymethyl, hydroxypropyl, hydroxypropylmethyl, methyl, hydroxyethyl, hydroxymethyl, ethyleneglycol or propylene glycol. Preferred derivatives include these polysaccharides (i.e. starch, xanthan gum, guar gum, diutan gum, locust bean gum, and combinations thereof) modified with hydroxypropyl, hydroxypropylmethyl, hydroxyethyl, or hydroxymethyl.

In another aspect of the invention, there is provided a method for the preparation of a stable aqueous liquid composition comprising the steps of:
(i) providing an aqueous liquid comprising a thiosulfate salt dissolved therein;
(ii) adding to the aqueous liquid provided in step (i) a solid and a rheology modifier to obtain a first blend; and
(iii) submitting the first blend of step (ii) to a mixing step suitable for converting it into a stable aqueous liquid composition.

In another aspect of the invention, there is provided a liquid composition obtainable by the method for the preparation of a stable aqueous liquid composition described herein.

In another aspect of the invention there is provided the use of the liquid composition as a fertilizer, preferably for fertilization through side dress, soil injection, spray (soil and/or foliar) or fertigation application, preferably spray or fertigation application. This use optionally comprises diluting the liquid composition of the invention with water before the spray or fertigation application. Typically spray application will be in the form of foliar application, but could also be spray application applied directly to soil.

### DETAILED DESCRIPTION

As used herein, the expression “wt. %”, when used in the context of an ionic compound (such as a thiosulfate or a sulfate), refers to the amount of the compound inclusive of its counterion.

As used herein, the expression “a stable aqueous liquid composition” should be interpreted to mean that the composition exhibits less than 10% (by total height of the formulation) of water layer development after 14 days storage in a closed container at 54° C. The test is preferably performed with 500 ml of the formulation stored in a graduated cylinder having an inner diameter within the range of 5-6 cm, which is closed with a stopper.

For the purpose of the present disclosure, the amount of suspended solids is determined based on the amount of particles with a particle size above 2 micron, which can easily be determined by the person skilled in the art by filtering particles with a size above 2 micron from an aliquot of the composition and determining their weight. Alternatively, the amount of suspended solids can be calculated based on the amount of insoluble material employed in the composition.

In a first aspect of the invention, there is provided a stable aqueous liquid composition comprising
water;
a thiosulfate salt dissolved in the aqueous liquid;
a solid suspended in the aqueous liquid; and
a rheology modifier.

It will be understood by the skilled person in the context of the present disclosure that the thiosulfate salt, the suspended solid and the rheology modifier are different compounds.

In preferred embodiments there is provided the liquid composition comprising:
water;
at least 5 wt. % (by total weight of the liquid composition) of a thiosulfate salt dissolved in the aqueous liquid;
at least 10 wt. % (by total weight of the liquid composition) of a solid suspended in the aqueous liquid; and
a rheology modifier.

The composition of the invention typically comprises a total amount of 10-90 wt. % (by total weight of the liquid composition) water, preferably 10-70 wt. %, more preferably 15-50 wt. %. The origin of the water present in the composition of the invention depends on how the composition is produced. Although the composition may be produced starting from a solid thiosulfate which is dissolved, the typical and most convenient way to produce the composition will be starting from a liquid thiosulfate product which is produced and sold as such (e.g. Thio-Sul® ammonium thiosulfate, KTS® potassium thiosulfate, CaTs® calcium thiosulfate or MagThio® magnesium thiosulfate available from Tessenderlo Kerley Inc), in which case the water present in the liquid composition of the invention originates partially or completely from the water already present in the liquid thiosulfate product.

A particular advantage of the composition of the present invention is that it can be provided with high amounts of dissolved sulfur in the form of thiosulfates, and still accommodate suspended solids in the form of a stable suspension. Hence, in preferred embodiments, the composition comprises at least 10 wt. % (by total weight of the liquid composition) of a thiosulfate salt dissolved in the aqueous liquid, preferably at least 15 wt. %, more preferably at least 18 wt. %.

Similarly, as is shown in the appended examples, it was found that extremely high loads of suspended solids can be provided in the liquid composition of the present invention. Hence, in preferred embodiments, the composition comprises at least 15 wt. % (by total weight of the liquid composition) of a solid suspended in the aqueous liquid, preferably at least 25 wt. %, more preferably at least 30 wt. %.

Particularly preferred embodiments of the present invention combine high sulfur loads in the form of dissolved thiosulfates with high loads of suspended solids. Hence, in preferred embodiments the composition comprises
at least 15 wt. % (by total weight of the liquid composition) of a solid suspended in the aqueous liquid; and
at least 5 wt. % (by total weight of the liquid composition) of a thiosulfate salt dissolved in the aqueous liquid; preferably
at least 25 wt. % (by total weight of the liquid composition) of a solid suspended in the aqueous liquid; and
at least 10 wt. % (by total weight of the liquid composition) of a thiosulfate salt dissolved in the aqueous liquid;
more preferably
at least 30 wt. % (by total weight of the liquid composition) of a solid suspended in the aqueous liquid; and
at least 15 wt. % (by total weight of the liquid composition) of a thiosulfate salt dissolved in the aqueous liquid.

The thiosulfate salt can in principle be any of the common thiosulfate salts, such as the alkaline metal thiosulfate salts, alkaline earth metal thiosulfate salts and ferrous thiosulfates. However, since plants do not tolerate sodium thiosulfate well, the thiosulfate is preferably selected from the group consisting of calcium thiosulfate, magnesium thiosulfate, potassium thiosulfate, ammonium thiosulfate, manganese thiosulfate, ferrous thiosulfate and combinations thereof, more preferably the thiosulfate salt is selected from the group consisting of calcium thiosulfate, potassium thiosulfate, ammonium thiosulfate and combinations thereof.

As is shown in the appended examples, the present inventors have found a further unexpected advantage when a major amount of calcium thiosulfate in the liquid phase is combined with a minor amount of another thiosulfate (such as ammonium thiosulfate or potassium thiosulfate). The minor amount of another thiosulfate was found to provide an unexpected and large additional stabilizing effect to the liquid composition, significantly extending its stable shelf-life. Hence, in particular embodiments, the thiosulfate salt comprised in the liquid composition of the present invention consists of a combination of a first thiosulfate salt and a second thiosulfate salt, wherein the first thiosulfate salt is calcium thiosulfate and the second thiosulfate salt is selected from magnesium thiosulfate, potassium thiosulfate, ammonium thiosulfate, manganese thiosulfate, ferrous thiosulfate and combinations thereof, preferably the second thiosulfate is selected from ammonium thiosulfate, potassium thiosulfate and combinations thereof, most preferably the second thiosulfate is ammonium thiosulfate. In these embodiments:
the ratio (w/w) of the first thiosulfate to the second thiosulfate is preferably within the range of 1:1 to 10:1, preferably within the range of 2:1 to 6:1; and/or
the concentration of the first thiosulfate is preferably more than 3 wt. % (by total weight of the liquid composition), more preferably more than 5 wt. % and the concentration of the second thiosulfate is preferably within the range of 0.1-5 wt. %, more preferably within the range of 0.5-3 wt. %.

The present inventors have found that in the thiosulfate based compositions of the present invention, ease of suspension of solid particles as well as the stability of the resulting composition is improved when the solid particles comply with a certain particle size distribution since particles which are too large tend to settle. Additionally, it was found that larger particles than the regular 20 micron upper limit which is usual for suspension concentrates may be employed in the formulations of the present invention. Hence, the suspended solid is preferably characterized by a Dv(25) of 5 micron or more and a Dv(75) of 100 micron or less as determined by laser diffraction. In preferred embodiments, the suspended solid has Dv(25) of 5 micron or more and a Dv(75) of 55 micron or less as determined by laser diffraction.

The particle size distribution of the suspended solid is preferably determined using a laser light diffraction particle size analyzer, such as the Beckman Coulter LS13320 or another instrument of equal or better sensitivity, wherein the particle size distribution is calculated using Mie theory of light scattering, assuming a volume equivalent sphere model. The particle size distribution of the suspended solid is preferably determined on dry powder before the solid is suspended into the liquid composition of the present invention. For this purpose, it is preferred to use the Beckman Coulter LS13320 equipped with a Tornado Dry Powder System. The terms Dv(25) and Dv(75) employed in the context of particle size are known to the skilled person and signify the particle size at which 25% and 75% respectively of the volume distribution is below said particle size.

The suspended solid preferably has the following additional particle size characteristics:
approximately 100 wt. % of particles pass through a 50 mesh (297 micron) screen, preferably through a 100 mesh (149 micron) screen; and
more than 85 wt. % of particles pass through a 100 mesh (149 micron) screen, preferably through a 200 mesh (74 micron) screen; and
more than 50 wt. % of particles pass through a 200 mesh (74 micron) screen, preferably through a 325 mesh (44 micron) screen.

The solid suspended in the aqueous liquid of the composition of the present invention can be any fertilizing solid, preferably a solid comprising a source of macronutrients selected from N, P, K, S, Ca, or Mg and/or a source of micronutrients selected from Fe, B, Mn, Zn, Cu, Mo, Ni, V, Co.

A non-limiting example of a source of macronutrients selected from N is Dicyandiamide (DCD).

A non-limiting example of a source of macronutrients selected from P is monocalcium phosphate or a hydrate thereof.

A non-limiting example of a source of macronutrients selected from K is potassium sulfate. As is known to the skilled person, potassium sulfate is only sparingly soluble, the exact solubility depending on the grade of potassium sulfate employed such that an insoluble phase of potassium sulfate can easily be provided.

A non-limiting example of a source of macronutrients selected from S is gypsum.

A non-limiting example of a source of macronutrients selected from Ca is gypsum.

A non-limiting example of a source of macronutrients selected from Mg is magnesium carbonate.

A non-limiting example of a source of micronutrients selected from Fe is iron(II) carbonate.

A non-limiting example of a source of micronutrients selected from B is zinc borate.

A non-limiting example of a source of micronutrients selected from Mn is manganese(II) phosphate or manganese(II) carbonate.

A non-limiting example of a source of micronutrients selected from Zn is zinc monocarbonate.

A non-limiting example of a source of micronutrients selected from Cu is copper(II) hydroxide.

A non-limiting example of a source of micronutrients selected from Mo is molybdenum(VI) oxide.

A non-limiting example of a source of micronutrients selected from Ni is nickel(II) phosphate.

A non-limiting example of a source of micronutrients selected from V is vanadium(III) sulfate.

A non-limiting example of a source of micronutrients selected from Co is cobalt(II) carbonate.

The present inventors have found that certain solids are particularly preferred as they perform surprisingly well in the thiosulfate composition of the present invention when considering e.g., ease of preparing the suspension, high solids load achievable, stability of the suspension, and particularly desirable nutritive profile of the resulting overall liquid composition, which is useful as a fertilizer. Among these particularly preferred solids are sulfate salts, carbonate salts, phosphate salts, and elemental sulfur. These are four groups of products which are notoriously difficult to provide as stable suspension, while liquid fertilizers comprising these products which are suitable for irrigation/foliar application are highly desirable.

In a preferred embodiment of the liquid composition of the present invention, the solids comprise a sulfate salt, preferably a sulfate salt selected from alkaline metal sulfates and alkaline earth metal sulfates, more preferably a sulfate selected from calcium sulfate, potassium sulfate, hydrates thereof and combinations thereof. In embodiments, the solid comprises more than 50 wt. % (by total weight of the solid) of the sulfate salt, preferably more than 80 wt. %, more preferably more than 95 wt. %. In embodiments, the solid consists essentially of the sulfate salt. It will be understood by the skilled person that the sulfate salt may be provided in the form of a hydrate, which is typical for calcium sulfate (the dihydrate form thereof is commonly known as “gypsum”). In case the solid comprises a sulfate salt in the form of a hydrate, for the purpose of wt. % calculations, the mass of the water of hydration is included in the mass of the sulfate salt. In highly preferred embodiments the solid comprises or consists of gypsum, which includes synthetic gypsum, recycled gypsum or mined gypsum. In a specifically envisaged embodiment of the present invention, the thiosulfate salt is calcium thiosulfate, and the solid is gypsum, and the total amount of calcium in the liquid composition is more than 10 wt. % and the total amount of sulfur in the liquid composition is more than 10 wt. %.

In a preferred embodiment of the liquid composition of the present invention, the solids comprise a carbonate salt, preferably a carbonate salt selected from alkaline metal carbonates and alkaline earth metal carbonates, more preferably a carbonate salt selected from calcium carbonate, magnesium carbonate, dolomite, and combinations thereof. It will be understood by the skilled person that the carbonate salt may be provided in the form of a hydrate, which is typical for magnesium carbonate. In case the solid comprises a carbonate salt in the form of a hydrate, for the purpose of wt. % calculations, the mass of the water of hydration is included in the mass of the carbonate salt. In embodiments, the solid comprises more than 50 wt. % (by total weight of the solid) of the carbonate salt, preferably more than 80 wt. %, more preferably more than 95 wt. %. In embodiments, the solid consists essentially of the carbonate salt.

In a preferred embodiment of the liquid composition of the present invention, the solids comprise a phosphate salt, preferably a phosphate salt selected from alkaline metal phosphates and alkaline earth metal phosphates, more preferably a phosphate salt selected from calcium phosphates. As used herein, the term “phosphates” encompasses monobasic, dibasic and tribasic phosphates, diphosphates, polyphosphates, hydrates thereof, and combinations thereof. As is known to the skilled person, phosphates are often obtained and sold as mixtures of the aforementioned phosphate compounds. In case the solid comprises a phosphate salt in the form of a hydrate, for the purpose of wt. % calculations, the mass of the water of hydration is included in the mass of the phosphate salt. In embodiments, the solid comprises more than 50 wt. % (by total weight of the solid) of the phosphate salt, preferably more than 80 wt. %, more preferably more than 95 wt. %. In embodiments, the solid consists essentially of the phosphate salt. The phosphate salt preferably comprises a major amount of monocalcium phosphate Ca(H₂PO₄)₂ or a hydrate thereof, such as more than 60 wt. % or more than 80 wt. % (by total weight of the phosphate salt).

In a preferred embodiment of the liquid composition of the present invention, the solids comprise elemental sulfur.

The rheology modifier included in the liquid composition of the invention can be any rheology modifier which, according to preferred embodiments, when add to demineralized water at a concentration of 1 g/100 ml water, results in a viscosity of more than 200 mPa*s (cps) as determined by “the viscosity protocol” defined herein elsewhere. Examples of such rheology modifiers may be found among naturally occurring clays (e.g. smectite, kaolinite, attapulgite), naturally occurring polysaccharides (e.g. gums) and derivatives thereof, proteins (in particular gelatins and hydrolysates thereof) or synthetic polymers. Suitable derivatives include the naturally occurring polysaccharides modified with acetate, carboxymethyl, hydroxypropyl, hydroxypropylmethyl, methyl, hydroxyethyl, hydroxymethyl, ethyleneglycol or propylene glycol.

Examples of suitable synthetic polymer rheology modifiers include polyacrylamides, polyacrylates, polyvinylpyrrolidones, polyamides (e.g. aromatic polyamides), polysulfonic acids, polyurethanes, polystearates, polyethers (e.g. polyethlene glycol), silicone-based polymers (e.g. polysiloxanes), alkylene oxide polymers, polyquaterniums.

Clays include exfoliated clays.

Proteins include any polypeptide rheology modifier without restriction to chain length. Particularly preferred protein rheology modifiers are gelatins and hydrolysates thereof. Gelatins hydrolysates in particular includes hydrolyzed collagen (also called collagen hydrolysates or collagen peptides).

The present inventors have found that polysaccharides are preferred rheology modifiers, especially when considering improved shelf-life stability and reduced risk of salting deposition/clogging during irrigation. Examples of suitable rheology modifiers, which are preferably polysaccharide rheology modifiers, are the compounds in the following group, provided that when the compound is added to demineralized water at a concentration of 1 g/100 ml water, it results in a viscosity of more than 200 mPa*s (cps) as determined by “the viscosity protocol” defined herein elsewhere: acacia gums, agar, arabic gums, arabinan, alginic acid or a salt thereof, apiogalacturonan, Arthrobacter viscosus NRRL 1973 Exopolysaccharide, Arthrobacter stabilis NRRL B3225 Exopolysaccharide, carrageenans, celluloses (e.g. MCC, CMC, MC and HPMC), chitin, chitosan, chondroitin sulfates, fucosylated chondroitin sulfates, colominic acid or a salt thereof, curdlan, dermatan sulfates, dextrans, diutan gums, fructans (e.g. inulins), fucoidans, furcellaran, gellan gums, ghatti gum, glycogen, hemicelluloses (e.g. mannans, galactomannans (in particular guar gum), xyloglucans, xylans, glucomannans, arabinoxylans, β-glucans (in particular from cereal, yeast, or fungi), arabinogalactans), hyaluronic acid or a salt thereof, ivory nut mannan, konjac, karaya gum, laminaran, levan, lichenan, isolichenan, locust bean gums, mucilage gums (e.g. yellow mustard mucilage, flaxseed mucilage, pysillium gum), pachyman, pachymaran, pectin, pectic arabinogalactans, pectic rhamnogalacturonans, peptidoglycan, polysialic acid or a salt thereof, porphyran, pullulan, putstulan, schizophyllans, scleriotium gums, scleroglucan, starches, tamarind gum, tara gum, teichuronic acids, tragacanth gum, ulvan, welan gum, xanthan gums, xylans, zymosan, derivatives thereof and combinations thereof. Suitable derivatives include acetate derivatives, carboxymethyl derivatives, hydroxypropyl derivatives, hydroxypropylmethyl derivatives, methyl derivatives, hydroxyethyl derivatives, hydroxymethyl derivatives, ethylene glycol derivative, and propylene glycol derivatives of the aforementioned polysaccharides. Preferred polysaccharide rheology modifiers within this group are water-soluble polysaccharides, wherein the expression “water-soluble polysaccharide” refers to a polysaccharide having a solubility of at least 0.5 g/100 ml water at 20° C.

As will be understood by the skilled person in the context of the present disclosure, the expression “Suitable derivatives include acetate derivatives, carboxymethyl derivatives, hydroxypropyl derivatives, hydroxypropylmethyl derivatives, methyl derivatives, hydroxyethyl derivatives, hydroxymethyl derivatives, ethylene glycol derivative, and propylene glycol derivatives of the aforementioned polysaccharides” or similar variants thereof is identical to the expression “Suitable derivatives include the aforementioned polysaccharides modified with acetate, carboxymethyl, hydroxypropyl, hydroxypropylmethyl, methyl, hydroxyethyl, hydroxymethyl, ethyleneglycol or propylene glycol”.

The present inventors have found that some gums result in a surprising further improved stability of the thiosulfate based suspensions of the present invention. Hence, it is preferred that the rheology modifier is selected from starch or a derivative thereof, xanthan gum or a derivative thereof, guar gum or a derivative thereof, diutan gum or a derivative thereof, locust bean gum or a derivative thereof, and combinations thereof. Suitable derivatives include acetate derivatives, carboxymethyl derivatives, hydroxypropyl derivatives, hydroxypropylmethyl derivatives, methyl derivatives, hydroxyethyl derivatives, hydroxymethyl derivatives, ethylene glycol derivatives, and propylene glycol derivatives of these polysaccharides. Preferred derivatives include hydroxypropyl derivatives, hydroxypropylmethyl derivatives, hydroxyethyl derivatives, and hydroxymethyl derivatives of these polysaccharides. In other words, suitable derivatives include these polysaccharides (i.e. starch, xanthan gum, guar gum, diutan gum, locust bean gum, and combinations thereof) modified with acetate, carboxymethyl, hydroxypropyl, hydroxypropylmethyl, methyl, hydroxyethyl, hydroxymethyl, ethyleneglycol or propylene glycol. Preferred derivatives include these polysaccharides (i.e. starch, xanthan gum, guar gum, diutan gum, locust bean gum, and combinations thereof) modified with hydroxypropyl, hydroxypropylmethyl, hydroxyethyl, or hydroxymethyl.

Particularly preferred are embodiments of the present invention wherein the rheology modifier consists of a first rheology modifier selected from xanthan gum combined with a second rheology modifier selected from starch or a derivative thereof and guar gum or a derivative thereof, preferably guar gum or a derivative thereof. Suitable starch or guar gum derivatives include acetate derivatives, carboxymethyl derivatives, hydroxypropyl derivatives, hydroxypropylmethyl derivatives, methyl derivatives, hydroxyethyl derivatives, hydroxymethyl derivatives, ethylene glycol derivatives, and propylene glycol derivatives.

Preferred starch or guar gum derivatives include hydroxypropyl derivatives, hydroxypropylmethyl derivatives, hydroxyethyl derivatives, and hydroxymethyl derivatives. In other words, suitable derivatives include starch or guar gum modified with acetate, carboxymethyl, hydroxypropyl, hydroxypropylmethyl, methyl, hydroxyethyl, hydroxymethyl, ethyleneglycol or propylene glycol. Preferred derivatives include starch or guar gum modified with hydroxypropyl, hydroxypropylmethyl, hydroxyethyl, or hydroxymethyl. In such embodiments the ratio (w/w) of the first rheology modifier to the second rheology modifier is preferably within the range of 10:1 to 1:2, preferably within the range of 10:1 to 1:1, more preferably within the range of 5:1 to 1:1, most preferably within the range of 2:1 to 1:1.

In accordance with preferred embodiments of the present invention, the rheology modifier is included in an amount of at least 0.01 wt. % (by total weight of the liquid composition), such as within the range of 0.01-15 wt. % (by total weight of the liquid composition), preferably within the range of 0.01-5 wt. % (by total weight of the liquid composition), preferably within the range of 0.05-2 wt. % (by total weight of the liquid composition), more preferably within the range of 0.1-1 wt. % (by total weight of the liquid composition).

The rheology modifier is typically included in an amount such that the resulting composition has a viscosity of 500-10000 mPa's (cps) as determined by “the viscosity protocol” defined herein elsewhere, preferably has a viscosity of 1000-4000 mPa*s (cps), more preferably has a viscosity of 1400-3200 mPa*s (cps), more preferably has a viscosity of 1700-3000 mPa*s (cps), more preferably has a viscosity of 2000-2700 mPa*s (cps).

The present inventors have found that it is possible to provide remarkably stable composition formulations according to the invention. Hence, the composition of the present invention preferably further exhibits the following stability characteristics:
a pH change of less than one pH unit, preferably less than 0.5 pH units after 14 days storage in a closed container at 54° C.; and
a change in thiosulfate content of less than 1 wt. %, preferably less than 0.5 wt. % after 14 days storage in a closed container at 54° C.; and
a viscosity change of less than 10% after 14 days storage in a closed container at 54° C., wherein the viscosity is determined by “the viscosity protocol” defined herein elsewhere;
wherein the stability test is preferably performed with 500 ml of the formulation stored in a graduated cylinder having an inner diameter within the range of 5-6 cm, which is closed with a stopper. It was also found that although a small water layer does develop after prolonged storage, the formulation is easily resuspended without the need for intensive mixing or special equipment.

A suitable method to determine the thiosulfate content is using the triple titration method which is generally known in the art and is described in ISO3619 (1994).

The composition of the present invention preferably has a pH within the range of 5 to 9, preferably within the range of 7-9. pH adjustment of the composition can be done using any acid or base conventionally used in the fertilizer industry for pH adjustment, such as, but not limited to: sulfuric acid, KOH, HCl, acetic acid, formic acid, nitric acid, citric acid, phosphoric acid, carbonates, etc. A particular advantage of the compositions of the present invention is that surprisingly no pH adjustment is necessary after formulation in order to bring the pH within a suitable range for plants and thus use as a fertilizer, hence a process step is eliminated.

The present inventors have found that the ease of preparing the suspension, as well as the stability of the suspension, may further be improved by including a dispersant. Dispersants are known to the skilled person and are a group of surfactants which work at the solid-liquid interface to stabilize solid particles against flocculation. Preferred dispersants for use in the context of the present invention are anionic surfactants. Preferably, the dispersant consists of one or more anionic surfactants selected from salts (preferably the alkaline metal or alkaline earth metal salt) of a compound represented by R—X; wherein X represents a sulfate group, a phosphate group, a sulfonate group, or a carboxylate group, preferably X represents a phosphate or sulfonate group; and wherein R is selected from:
branched or straight-chain C₅-C₂₄ alkyls;
branched or straight chain mono-unsaturated C₅-C₂₄ alkenyls;
branched or straight chain poly-unsaturated C₅-C₂₄ alkenyls;
alkylbenzene groups comprising a C₁-C₁₅ alkyl;
alkenylbenzene groups comprising a C₂-C₁₅ alkenyl;
alkylnaphthalene groups comprising a C₁-C₁₅ alkyl;
alkenylnaphthalene groups comprising a C₂-C₁₅ alkenyl;
alkylphenol groups comprising a C₁-C₁₅ alkyl;
alkenylphenol groups comprising a C₂-C₁₅ alkenyl;
succinic acid esters comprising two C₈-C₁₅ alkyls;
ethoxylated C₅-C₂₄ alkyls;
C₅-C₂₄ fatty acid methyl esters, optionally comprising one or more hydroxyl groups; and
lignins.

The present inventors have found that the following dispersants outperform other dispersants when considering the ease of preparing the suspension, as well as the stability of the suspension. Hence, in preferred embodiments of the invention the dispersant is preferably selected from the group consisting of:
sulfonates of branched or straight-chain C₅-C₂₄ alkyls;
sulfonates of alkylnaphthalene groups comprising a C₁-C₁₅ alkyl;
sulfonates of alkylbenzene groups comprising a C₁-C₁₅ alkyl;
phosphate esters of ethoxylated C₅-C₂₄ alkyls;
lignosulfonates; and
combinations thereof.

A non-limiting example of a suitable sulfonate of branched or straight-chain C₅-C₂₄ alkyls is an octanesulfonate salt (e.g. a potassium salt).

A non-limiting example of a suitable sulfonate of alkylnaphthalene groups comprising a C₁-C₁₅ alkyl is Morwet D-400 available from Nouryon

A non-limiting example of a suitable sulfonate of alkylbenzene groups comprising a C₁-C₁₅ alkyl is a xylene sulfonate salt (e.g. potassium salt), which is widely commercially available.

A non-limiting example of a suitable phosphate ester of ethoxylated C₅-C₂₄ alkyls is a tridecyl alcohol ethoxylate phosphate ester salt (e.g. potassium salt), which is widely commercially available.

In accordance with preferred embodiments of the present invention, the dispersant is included in an amount within the range of 0.05-10 wt % (by total weight of the liquid composition), preferably 0.1-8 wt. %, more preferably 0.5-5 wt. %.

The present inventors have found that the ease of preparing the suspension, as well as the stability of the suspension, may further be improved by including a wetting agent. Wetting agents are known to the skilled person and are a group of surfactants which work at the air-water interface to lower the surface tension of water and facilitate substituting air in agglomerate particles by liquid. Preferred wetting agents for use in the context of the present invention are non-ionic surfactants such as alcohol ethoxylates, fatty acid ethoxylates, ethoxylated amines, ethoxylated fatty acid amides, poloxamers, fatty acid esters of glycerol, fatty acid esters of sorbitol, fatty acid esters of sucrose, alkyl polyglucosides and combinations thereof. The present inventors have found that alcohol ethoxylates significantly outperform other wetting agents when considering the ease of preparing the suspension, as well as the stability of the suspension. Hence, the wetting agent is preferably selected from the group consisting of alcohol ethoxylates, such as linear C₆-C₁₅ ethoxylates, alkylphenol ethoxylates (such as octylphenol or nonylphenol ethoxylates) and combinations thereof. Preferred alcohol ethoxylates are C₉-C₁₁ alkyl ethoxylates (such as Biosoft® N91-6 available from Stepan) and nonylphenol ethoxylates.

In accordance with preferred embodiments of the present invention, the wetting agent is included in an amount within the range of 0.05-10 wt % (by total weight of the liquid composition), preferably 0.1-5 wt. %, more preferably 0.5-2 wt. %.

The liquid composition of the present invention may include further additives, such as (but not limited to) a biocide, an antifoam agent, a corrosion inhibitor, an anti-scaling agent, a fungicide, a herbicide, an insecticide, a nematicide, a biostimulant, chelated metals, other fertilizing ingredients, etc.

A biocide is an antimicrobial agent which can limit the growth of any bacteria or fungus in the formulation, thus maintaining stability and preventing spoilage of the formulation during long term storage. Exemplary biocides are 5-chloro-2-methyl-2H-isothiazol-3-one, 2-methyl-2H-isothiazol-3-one, bronopol (2-bromo-2-nitropropane-1,3-diol), sodium nitrite, 1,2-benzisothiazolin-3-one, glutaraldehyde, sodium o-phenylphenate, 2,2-dibromo-3-nitrilopropionamide, sodium hypochlorite, trisodium phosphate, and combinations thereof. A biocide is typically used in a concentration of 0.005-0.5 wt. % (by total weight of the liquid composition), preferably 0.01-0.2 wt. %.

An antifoam agent is a chemical additive that reduces and hinders the formation of foam during production and use of the liquid composition. Exemplary antifoam agents are polyolefins, polyalkylene oxides, polydimethylsiloxanes, stearates, polyalkylene glycols, and combinations thereof. An antifoam agent is typically used in a concentration of 0.005-0.5 wt. % (by total weight of the liquid composition), preferably 0.01-0.15 wt. %.

Examples of other fertilizing ingredients employed in the composition, such as may be dissolved in the liquid composition, include a source of macronutrients selected from N, P, K, S, Ca, or Mg and/or a source of micronutrients selected from Fe, B, Mn, Zn, Cu, Mo, Ni, V, Co.

In another aspect, the present invention concerns a method for the preparation of a composition as described herein comprising the steps of:
(i) providing an aqueous liquid comprising a thiosulfate salt dissolved therein;
(ii) adding to the aqueous liquid provided in step (i) a solid and a rheology modifier to obtain a first blend; and
(iii) submitting the first blend of step (ii) to a mixing step suitable for converting it into a stable aqueous liquid composition.

As will be understood by the skilled person, all embodiments described herein for the liquid composition of the invention, for example relating to the identity and concentrations of the different components, or the stability and viscosity of the resulting product are equally applicable to the method for the preparation of the composition.

It was advantageously found that the compositions of the present invention do not require special high-energy input mixing in order to achieve a stable suspension. Hence, the mixing in step (iii) can be performed by hand mixing using a spatula, by a regular magnetic stir bar or by a hand-held kitchen mixer. While high-shear mixers can be employed, the present inventors found that they are not necessary and even not desirable as they tend to break down the rheology modifier if employed at too high intensities or for too long.

The method may comprise an additional step of adding water to the aqueous liquid of step (i), to the first blend of step (ii) or during the mixing of step (iii). The solid added in step (ii) of the method may be added as a dry product, or in the form of a suspension or slurry, such as an aqueous suspension or slurry. The rheology modifier added in step (ii) of the method may be added as a dry product, or in the form of a mixture with water, which can take the identity of e.g. a solution, suspension, slurry or simply a hydrated rheology modifier. Preferably the rheology modifier added in step (ii) is added in the form of a mixture with water.

Advantageously, the method of the present invention allows the liquid composition to be prepared from commercially available liquid thiosulfate compositions, starting from a liquid thiosulfate product which is produced and sold as such (e.g. Thio-Sul®, KTS®, CaTs® or MagThio® available from Tessenderlo Kerley Inc). As explained herein elsewhere, it was surprisingly found that these products, which already contain high thiosulfate concentrations close to the solubility limit, can be used as liquid bulk for providing stable suspensions of further solids. Hence, in preferred embodiments, step (i) of the method comprises providing an aqueous liquid comprising a thiosulfate salt dissolved therein, wherein the aqueous liquid contains:
ammonium thiosulfate in an amount resulting in a nitrogen content (as ammoniacal nitrogen) of more than 10 wt. % (by total weight of the aqueous liquid provided in step (i)) and a sulfur content of more than 26 wt. % (by total weight of the aqueous liquid provided in step (i));
potassium thiosulfate in an amount resulting in a potassium content (as K₂O) of more than 22 wt. % (by total weight of the aqueous liquid provided in step (i)) and a sulfur content of more than 15 wt. % (by total weight of the aqueous liquid provided in step (i));
calcium thiosulfate in an amount resulting in a calcium content of more than 5 wt. % (by total weight of the aqueous liquid provided in step (i)) and a sulfur content of more than 8 wt. % (by total weight of the aqueous liquid provided in step (i)); or
magnesium thiosulfate in an amount resulting in a magnesium content of more than 3 wt. % (by total weight of the aqueous liquid provided in step (i)) and a sulfur content of more than 8 wt. % (by total weight of the aqueous liquid provided in step (i));
preferably
ammonium thiosulfate in an amount resulting in a nitrogen content (as ammoniacal nitrogen) of more than 10 wt. % (by total weight of the aqueous liquid provided in step (i)) and a sulfur content of more than 26 wt. % (by total weight of the aqueous liquid provided in step (i)).

In another aspect, the invention concerns the use of the liquid composition as provided herein as a fertilizer. In particular embodiments, the invention concerns the use of the liquid composition as provided herein which is a liquid fertilizer, for providing nutrients to plants. In particular, there is provided the use of the liquid composition as provided herein for fertilization through side dress, soil injection, spray (soil and/or foliar) or fertigation application, preferably spray or fertigation application. This use optionally comprises diluting the liquid composition of the invention with water before the spray or fertigation application. Typically spray application will be in the form of foliar application, but could also be spray application applied directly to soil or injected into the soil.

In another aspect the invention concerns the use of a thiosulfate salt selected from magnesium thiosulfate, potassium thiosulfate, ammonium thiosulfate, manganese thiosulfate, ferrous thiosulfate and combinations thereof, preferably selected from ammonium thiosulfate, potassium thiosulfate and combinations thereof, most preferably ammonium thiosulfate, to improve the stability of a liquid composition comprising at least 5 wt. % (by total weight of the liquid composition) of calcium thiosulfate dissolved in the aqueous liquid, and at least 10 wt. % (by total weight of the liquid composition) of a solid suspended in the aqueous liquid. In preferred embodiments, the use to improve the stability of the liquid composition comprises increasing the time until visible phase separation occurs when the liquid composition is stored in a closed recipient and not agitated. Preferably the time until visible phase separation occurs is increased by at least 20%, preferably by at least 50% compared to a control which has an otherwise identical composition but wherein all thiosulfates other than calcium thiosulfate are replaced by an equal weight amount of calcium thiosulfate.

### EXAMPLES

The composition described in the following examples were prepared by a simple protocol consisting of (i) providing the thiosulfate salt in the form of an aqueous solution; (ii) addition of the solid into the aqueous thiosulfate solution, together with some water, and mixing for 5 minutes to create a suspension; (iii) hydrating the rheology modifier; (iv) addition of the hydrated rheology modifier and any other ingredients into the suspension and mixing by hand using a spatula or using a magnetic stir bar. Hydrating the rheology modifier can be done by simply adding water to the rheology modifier and waiting about 24 hours. Hydration can be sped up by adding an aqueous solution of wetting agent (if employed in the formulation) to the rheology modifier.

The calcium thiosulfate, ammonium thiosulfate and potassium thiosulfate referred to in the below tables was provided in the form of a thiosulfate solution, namely CaTs® (24% calcium thiosulfate, 76% water), Thio-Sul® (58% ammonium thiosulfate, 42% water) and KTS® (50% potassium thiosulfate, 50% water) respectively, available from Tessenderlo Kerley Inc. The tables list the amount of thiosulfate salt as such, and the total amount of water present in the formulation, which includes water originating from the thiosulfate solution as well as additional water which was added when preparing the suspension and when hydrating the rheology modifier to reach the listed total amount of water.

The following protocol was used to determine the viscosity of the liquid compositions (referred to throughout the present disclosure as “The viscosity protocol”): The viscosity is measured employing a Brookfield DV3T Rheometer. 15 mL of the formulation is transferred to a small sample adaptor and agitated for 5 minutes at 30 rpm using an SC4-27 spindle. The reference temperature is set at 23ºC and the percent torque reads over 10%. The viscosity in centipoise is taken at the 5-minute mark.

The calcium polysulfide was provided in the form of a polysulfide solution comprising 24% calcium polysulfide and 76% water. The table lists the amount of polysulfide salt as such, and the total amount of water present in the formulation, which includes water originating from the polysulfide solution as well as additional water which was added to reach the listed total amount of water.

The gypsum employed was premium 97 solution grade gypsum sold by Diamond K, containing 97.1% calcium sulfate dihydrate and having a granulation pattern wherein 100% of gypsum passes through a #100 mesh screen, 99% passes through a #200 mesh screen and 85% passes through a #325 mesh screen. The particle size characteristics as determined on dry powder by a Beckman Coulter LS13320 employing a Tornado Dry Powder System were as follows: Dv(10): 1.8 micron; Dv(25): 8.1 micron; Dv(50): 24.7 micron; Dv(75): 51.9 micron; Dv(90): 79.8 micron. The Beckman Coulter LS13320 is a laser light diffraction particle size analyzer wherein the particle size distribution is calculated using Mie theory of light scattering, assuming a volume equivalent sphere model.

The modified starch was provided in the form of a 10 wt. % aqueous solution (the amount of water being included in the total amount of water listed in the below table). The starch solution was heated before adding the starch to the rest of the formulation, in order to promote gelling behaviour.

### Example (Amounts in Wt. %)

| Function | Compound | 1 | 2 | 3 | 4 | 5 |
|---|---|---|---|---|---|---|
| Dissolved fertilizer | Calcium thiosulfate | 10.03 | 10.03 | 10.03 | 6.05 | 6.05 |
| Suspended fertilizer | Gypsum | 41.20 | 41.20 | 41.20 | 45.50 | 45.50 |
| Rheology modifier | Xanthan Gum | 0.14 | 0.20 | 0.20 | 0.17 | 0.17 |
| Rheology modifier | Modified Starch | 0.50 | 0 | 0 | 0 | 0 |
| Rheology modifier | Modified Guar | 0 | 0 | 0 | 0.12 | 0.12 |
| Biocide | Proxel GXL | 0.10 | 0.10 | 0.10 | 0.10 | 0.10 |
| Wetting agent | Alcohol Ethoxylate | 1.00 | 1.00 | 0 | 1.50 | 0.00 |
| Dispersant | Xylene sulfonate | 0 | 0 | 1.00 | 0 | 1.50 |
| Dispersant | Lignosulfonate | 1.50 | 0 | 0 | 0 | 0 |
| Dispersant | Tridecyl alcohol | 0 | 1.50 | 1.50 | 3.00 | 3.00 |
| | ethoxylate | | | | | |
| | phosphate ester, | | | | | |
| | potassium salt | | | | | |
| Continuous phase | Water | 45.53 | 45.97 | 45.97 | 43.57 | 43.57 |

| | | | | | |
|---|---|---|---|---|---|
| Total | 100 | 100 | 100 | 100 | 100 |

### Example (Amounts in Wt. %)

| Function | Compound | 6 | 7 | 8 | 9 | 10 |
|---|---|---|---|---|---|---|
| Dissolved fertilizer | potassium thiosulfate | 8.00 | 0 | 0 | 18.00 | 19.00 |
| Dissolved fertilizer | ammonium thiosulfate | 0 | 9.28 | 20.88 | 0 | 0 |
| Suspended fertilizer | Gypsum | 45.50 | 45.50 | 0 | 0 | 0 |
| Suspended fertilizer | CaCO₃ | 0 | 0 | 44.00 | 44.00 | 0 |
| Suspended fertilizer | K₂SO₄ | 0 | 0 | 0 | 0 | 37.00 |
| Rheology modifier | Xanthan Gum | 0.18 | 0.18 | 0.18 | 0.18 | 0.25 |
| Rheology modifier | Modified Guar | 0.10 | 0.10 | 0 | 0 | 0.25 |
| Biocide | Proxel GXL | 0.10 | 0.10 | 0.10 | 0.10 | 0.20 |
| Wetting agent | Alcohol Ethoxylate | 1.50 | 1.50 | 0 | 0 | 0 |
| Wetting agent | Nonylphenol ethoxylate | 0 | 0 | 0 | 0 | 1.5 |
| Dispersant | Sodium alkane sulfonate | 0 | 0 | 1.50 | 1.50 | 0 |
| Dispersant | Lignosulfonate | 3.00 | 3.00 | 3.00 | 3.00 | 3.00 |
| Continuous phase | Water | 41.64 | 40.36 | 30.34 | 33.22 | 38.80 |

| | | | | | |
|---|---|---|---|---|---|
| Total | 100 | 100 | 100 | 100 | 100 |

### Example (Amounts in Wt. %)

| Function | Compound | 11 | 12 | 13 | 14 | 15 | 16 |
|---|---|---|---|---|---|---|---|
| Dissolved fertilizer | potassium thiosulfate | 0 | 0 | 0 | 0 | 0 | 1.5 |
| Dissolved fertilizer | ammonium thiosulfate | 19.72 | 19.72 | 0 | 0 | 1.74 | 0 |
| Dissolved fertilizer | calcium thiosulfate | 0 | 0 | 10.03 | 6.05 | 6.05 | 6.05 |
| Suspended fertilizer | monocalcium phosphate (anhydrous) | 0 | 34.00 | 0 | 0 | 0 | 0 |
| Suspended fertilizer | Gypsum | 0 | 0 | 41.20 | 45.50 | 45.50 | 45.50 |
| Suspended fertilizer | Elemental sulfur | 34.00 | 0 | 0 | 0 | 0 | 0 |
| Rheology modifier | Xanthan Gum | 0.18 | 0.19 | 0 | 0.17 | 0.17 | 0.17 |
| Rheology modifier | Diutan Gum | 0 | 0 | 0.12 | 0 | 0 | 0 |
| Rheology modifier | Modified Guar | 0 | 0 | 0 | 0.12 | 0.12 | 0.12 |
| Biocide | Proxel GXL | 0.10 | 0.10 | 0.10 | 0.10 | 0.10 | 0.10 |
| Wetting agent | Alcohol Ethoxylate | 1.50 | 1.50 | 1.00 | 1.50 | 1.50 | 1.50 |
| Dispersant | Lignosulfonate | 3.00 | 3.00 | 1.50 | 3.00 | 3.00 | 3.00 |
| Continuous phase | Water | 41.50 | 41.50 | 46.05 | 43.6 | 41.83 | 42.07 |

| | | | | | | |
|---|---|---|---|---|---|---|
| Total | 100 | 100 | 100 | 100 | 100 | 100 |

The formulations of examples 1-5 were subjected to stability testing at 54° C. for 14 days in a closed container. It was found that they exhibited less than 10% (by total height of the formulation) of water layer development, and it was found that pH was stable (less than 0.5 pH value difference), thiosulfate content was stable (less than 0.5% wt. % difference) and viscosity was stable (less than 10% difference). Viscosity was determined before and after the test using the viscosity protocol defined herein elsewhere.

The formulations of examples 1-16 were subjected to 6-month stability testing at room temperature, being stored in identical containers without any agitation being applied during the period of stability testing.

It was found that they exhibited less than 10% (by total height of the formulation) of water layer development, and it was found that pH was stable (less than 0.5 pH value difference), thiosulfate content was stable (less than 0.5% wt. % difference) and viscosity was stable (less than 10% difference). Viscosity was determined before and after the test using the viscosity protocol defined herein elsewhere. The pH of the formulations of examples 1-16 was in the range of 7.5-8.5.

Examples 15 and 16 correspond to the formulation of example 14 with a small amount of potassium thiosulfate or ammonium thiosulfate additionally included. It was observed that when identical amounts of examples 14-16 were stored in identical containers for 6 months at room temperature, the water layer developed on each of formulations 15 and 16 was less than 50% of the water layer developed on formulation 14.

### Comparative Examples 17 & 18

Two formulations 17 and 18 corresponding to the formulations of examples 4 and 5 but employing calcium polysulfide instead of calcium thiosulfate were prepared. It was not possible to achieve a stable suspension. In fact, phase separation and strong precipitation was already observed within minutes of preparing the formulation.

### Comparative Example 19

A formulation corresponding to the formulation of example 4 was prepared but employing ammonium sulfate instead of gypsum. An insoluble double salt of ammonium sulfate and gypsum was formed which is prone to clogging irrigation lines.

1. A stable aqueous liquid composition comprising
water;
a thiosulfate salt dissolved in the aqueous liquid;
a solid suspended in the aqueous liquid; and
a rheology modifier,
wherein the thiosulfate salt, the suspended solid and the rheology modifier are different compounds.

2. The composition of claim 1 comprising
10-90 wt. % (by total weight of the liquid composition) water;
at least 5 wt. % (by total weight of the liquid composition) of a thiosulfate salt dissolved in the aqueous liquid;
at least 10 wt. % (by total weight of the liquid composition) of a solid suspended in the aqueous liquid; and
at least 0.01 wt. % (by total weight of the liquid composition) of a rheology modifier.

3. The composition of claim 1 comprising the rheology modifier in an amount such that the composition has a viscosity within the range of 500-10,000 mPa*s (cps).

4. The composition of claim 1, wherein the thiosulfate salt is selected from the group consisting of calcium thiosulfate, magnesium thiosulfate, potassium thiosulfate, ammonium thiosulfate, ferrous thiosulfate, manganese thiosulfate and combinations thereof, preferably wherein the thiosulfate salt is selected from the group consisting of calcium thiosulfate, potassium thiosulfate, ammonium thiosulfate and combinations thereof.

5. The composition of claim, wherein the thiosulfate salt consists of a combination of a first thiosulfate salt and a second thiosulfate salt, wherein the first thiosulfate salt is calcium thiosulfate and the second thiosulfate salt is selected from magnesium thiosulfate, potassium thiosulfate, ammonium thiosulfate, manganese thiosulfate, ferrous thiosulfate and combinations thereof, preferably the second thiosulfate is selected from ammonium thiosulfate, potassium thiosulfate and combinations thereof, most preferably the second thiosulfate is ammonium thiosulfate, and wherein the ratio (w/w) of the first thiosulfate salt to the second thiosulfate salt is within the range of 1:1 to 10:1, preferably within the range of 2:1 to 6:1.

6. The composition of claim 1, wherein the suspended solid comprises a source of macronutrients selected from N, P, K, S, Ca, or Mg and/or a source of micronutrients selected from Fe, B, Mn, Zn, Cu, Mo, Ni, V, Co.

7. The composition of claim 1, wherein the suspended solid comprises a sulfate salt, a carbonate salt, a phosphate salt or elemental sulfur.

8. The composition of claim 1, wherein the suspended solid has Dv(25) of 5 micron or more and a Dv(75) of 100 micron or less as determined by laser diffraction.

9. The composition of claim 1, further comprising 0.05-10 wt % (by total weight of the liquid composition) of a dispersant, preferably 0.1-8 wt. %, more preferably 0.5-5 wt. %, wherein the dispersant consists of one or more anionic surfactants selected from salts of a compound represented by R—X; wherein X represents a sulfate group, a phosphate group, a sulfonate group, or a carboxylate group, and wherein R is selected from:
branched or straight-chain C₅-C₂₄ alkyls;
branched or straight chain mono-unsaturated C₅-C₂₄ alkenyls;
branched or straight chain poly-unsaturated C₅-C₂₄ alkenyls;
alkylbenzene groups comprising a C₁-C₁₅ alkyl;
alkenylbenzene groups comprising a C₂-C₁₅ alkenyl;
alkylnaphthalene groups comprising a C₁-C₁₅ alkyl;
alkenylnaphthalene groups comprising a C₂-C₁₅ alkenyl;
alkylphenol groups comprising a C₁-C₁₅ alkyl;
alkenylphenol groups comprising a C₂-C₁₅ alkenyl;
succinic acid esters comprising two C₈-C₁₅ alkyls;
ethoxylated C₅-C₂₄ alkyls;
C₅-C₂₄ fatty acid methyl esters, optionally comprising one or more hydroxyl groups; and
lignins.

10. The composition of claim 9 wherein the dispersant is selected from the group consisting of:
sulfonates of branched or straight-chain C₅-C₂₄ alkyls;
sulfonates of alkylnaphthalene groups comprising a C₁-C₁₅ alkyl;
sulfonates of alkylbenzene groups comprising a C₁-Cis alkyl;
phosphate esters of ethoxylated C₅-C₂₄ alkyls;
lignosulfonates; and
combinations thereof.

11. The composition of claim 1, wherein the rheology modifier is selected from the group consisting of naturally occurring clays, proteins, naturally occurring polysaccharides and derivatives thereof, synthetic polymers, and combinations thereof,
wherein the derivatives of naturally occurring polysaccharides are selected from naturally occurring polysaccharides modified with acetate, carboxymethyl, hydroxypropyl, hydroxypropylmethyl, methyl, hydroxyethyl, hydroxymethyl, ethylene glycol, or propylene glycol.

12. The composition of claim 11 wherein the rheology modifier is a polysaccharide rheology modifier selected from the group consisting of acacia gums, agar, arabic gums, arabinan, alginic acid or a salt thereof, apiogalacturonan, Arthrobacter viscosus NRRL 1973 Exopolysaccharide, Arthrobacter stabilis NRRL B3225 Exopolysaccharide, carrageenans, celluloses (e.g. MCC, CMC, MC and HPMC), chitin, chitosan, chondroitin sulfates, fucosylated chondroitin sulfates, colominic acid or a salt thereof, curdlan, dermatan sulfates, dextrans, diutan gums, fructans (e.g. inulins), fucoidans, furcellaran, gellan gums, ghatti gum, glycogen, hemicelluloses (e.g. mannans, galactomannans, xyloglucans, xylans, glucomannans, arabinoxylans, β-glucans (in particular from cereal, yeast, or fungi), arabinogalactans), hyaluronic acid or a salt thereof, ivory nut mannan, konjac, karaya gum, laminaran, levan, lichenan, isolichenan, locust bean gums, mucilage gums (e.g. yellow mustard mucilage, flaxseed mucilage, pysillium gum), pachyman, pachymaran, pectin, pectic arabinogalactans, pectic rhamnogalacturonans, peptidoglycan, polysialic acid or a salt thereof, porphyran, pullulan, putstulan, schizophyllans, scleriotium gums, scleroglucan, starches, tamarind gum, tara gum, teichuronic acids, tragacanth gum, ulvan, welan gum, xanthan gums, xylans, zymosan, derivatives thereof and combinations thereof,
wherein the derivatives are selected from the aforementioned polysaccharides modified with acetate, carboxymethyl, hydroxypropyl, hydroxypropylmethyl, methyl, hydroxyethyl, hydroxymethyl, ethylene glycol, or propylene glycol.

13. The composition of claim 12 wherein the rheology modifier is selected from the group consisting of starch or a derivative thereof, xanthan gum or a derivative thereof, guar gum or a derivative thereof, diutan gum or a derivative thereof, locust bean gum or a derivative thereof, and combinations thereof,
wherein the derivatives are selected from the aforementioned polysaccharides modified with acetate, carboxymethyl, hydroxypropyl, hydroxypropylmethyl, methyl, hydroxyethyl, hydroxymethyl, ethylene glycol, or propylene glycol.

14. The composition of claim 1, wherein the rheology modifier, when added to demineralized water at a concentration of 1 g/100 ml water, results in a viscosity of more than 200 cps.

15. The composition of claim 1, further comprising 0.05-10 wt % (by total weight of the liquid composition) of a wetting agent, preferably 0.1-5 wt. %, more preferably 0.5-2 wt. %, wherein the wetting agent is a non-ionic surfactant selected from the group consisting of alcohol ethoxylates, fatty acid ethoxylates, ethoxylated amines, ethoxylated fatty acid amides, poloxamers, fatty acid esters of glycerol, fatty acid esters of sorbitol, fatty acid esters of sucrose, alkyl polyglucosides and combinations thereof.

16. (canceled)

17. A method for the preparation of a composition comprising the steps of:
providing an aqueous liquid comprising water and a thiosulfate salt dissolved therein, a solid suspended in the aqueous solution liquid, a rheology modifier;
adding to the aqueous liquid provided in step (i) a solid and a rheology modifier to obtain a first blend; and
submitting the first blend of step (ii) to a mixing step suitable for converting it into a stable composition,
wherein the thiosulfate salt, the suspended solid, and the rheology modifier are different compounds.

18. The method of claim 17 wherein the aqueous liquid provided in step (i) contains:
ammonium thiosulfate in an amount resulting in a nitrogen content (as ammoniacal nitrogen) of more than 10 wt. % (by total weight of the aqueous liquid provided in step (i)) and a sulfur content of more than 26 wt. % (by total weight of the aqueous liquid provided in step (i)); or
potassium thiosulfate in an amount resulting in a potassium content (as K₂O) of more than 22 wt. % (by total weight of the aqueous liquid provided in step (i)) and a sulfur content of more than 15 wt. % (by total weight of the aqueous liquid provided in step (i)); and
calcium thiosulfate in an amount resulting in a calcium content of more than 5 wt. % (by total weight of the aqueous liquid provided in step (i)) and a sulfur content of more than 8 wt. % (by total weight of the aqueous liquid provided in step (i)); or
magnesium thiosulfate in an amount resulting in a magnesium content of more than 3 wt. % (by total weight of the aqueous liquid provided in step (i)) and a sulfur content of more than 8 wt. % (by total weight of the aqueous liquid provided in step (i));
wherein preferably the aqueous liquid provided in step (i) contains:
ammonium thiosulfate in an amount resulting in a nitrogen content (as ammoniacal nitrogen) of more than 10 wt. % (by total weight of the aqueous liquid provided in step (i)) and a sulfur content of more than 26 wt. % (by total weight of the aqueous liquid provided in step (i)).

19. A method of fertilization comprising:
applying a liquid fertilizer composition, wherein the liquid fertilizer composition comprises:
water;
a thiosulfate salt dissolved in the aqueous liquid;
a solid suspended in the aqueous liquid; and
a rheology modifier,
wherein the thiosulfate salt, the suspended solid and the rheology modifier are different compounds; and
wherein applying includes side dress, soil injection, spray (soil and/or foliar), or fertigation application.
